(19) United States
(12) Patent Application Publication
(10) Pub. No.: US 2011/0114549 A1
(43) Pub. Date: May 19, 2011

(54) MICROFLUIDIC DEVICE COMPRISING SEPARATION COLUMNS

(75) Inventors: Hongfeng Yin, Cupertino, CA (US); Kevin Killeen, Woodside, CA (US); Karsten Kraiczek, Waldbronn (DE)

(73) Assignee: AGILENT TECHNOLGIES, INC., Loveland, CO (US)

(21) Appl. No.: 12/617,926

(22) Filed: Nov. 13, 2009

(51) Int. Cl. B01D 15/22

(52) U.S. Cl. 210/198.2

(57) ABSTRACT

A microfluidic chip comprises a first substantially linear separation column having a first length, the first separation column comprising a first stationary phase particle density distribution along the first length; and a second substantially linear separation column having a second length connected in series with the first separation column, the second separation column comprising a second stationary phase particle density distribution along the second length.

### BACKGROUND

Chemical and biological separations are routinely performed in various industrial and academic settings to determine the presence and/or quantity of individual species in complex sample mixtures. There exist various techniques for performing such separations.

One particularly useful analytical process is chromatography, which encompasses a number of methods that are used for separating ions or molecules for analysis. Liquid chromatography ('LC') is a physical method of separation wherein a liquid ‘mobile phase’ carries a sample containing multiple molecules or ions for analysis (analytes) through a separation medium or ‘stationary phase.’ Stationary phase material typically includes a liquid-permeable medium such as packed granules (particulate material) or a microporous matrix (e.g., porous monolith) disposed within a tube or similar boundary. The resulting structure including the packed material or matrix contained within the tube is commonly referred to as a ‘separation column.’ In the interest of obtaining greater separation efficiency, so-called ‘high performance liquid chromatography’ ('HPLC') methods often utilizing high operating pressures are commonly used.

In recent years, microdevice technologies, also referred to as microfluidic technologies and Lab-on-a-Chip technologies, have been used in LC and HPLC applications. These microdevices are useful in many applications, particularly in applications that involve rare or expensive analytes, such as proteomics and genomics. Furthermore, the small size of the microdevices allows for the analysis of minute quantities of sample.

Microdevices (or often referred to as microfluidic devices) may be adapted to carry out a number of different separation techniques. Capillary electrophoresis (CE), for example, separates molecules based on differences in the electrophoretic mobility of the molecules. Typically, microfluidic devices employ a controlled application of an electric field to induce fluid flow and or to provide flow switching. In order to effect reproducible and/or high-resolution separation, a fluid sample ‘plug,’ a predetermined volume of fluid sample, must be controllably injected into a capillary separation column or conduit. For fluid samples containing high molecular weight charged biomolecular analytes such as DNA fragments and proteins, microdevices containing a capillary electrophoresis separation conduit a few centimeters in length may be effectively used in carrying out sample separation of small volumes of fluid sample having a length on the order of micrometers. Once injected, high sensitivity detection such as laser-induced fluorescence (LIF) may be employed to resolve a separated fluorescently-labeled sample component.

For samples containing analyte molecules with low electrophoretic differences, such as those containing small drug molecules, the separation technology of choice is often based LC, and particularly HPLC. As described, in LC, separation occurs when the mobile phase carries sample molecules through the stationary phase where sample molecules interact with the stationary phase surface. The velocity at which a particular sample component travels through the stationary phase depends on the component's partition between mobile phase and stationary phase.

Among other desired results, it is useful to provide separated analytes to a detector. The better the resolution of the absorption peaks of the analytes that is obtained, the more accurate is the liquid chromatography in analyzing a sample. One way to improve the separation and thus the resolution of the absorption peaks is to improve the retention behavior of the stationary phase of the separation column. For a given particle size, one way to improve the retention behavior is to provide microfluidic columns having a greater length. As is known, for a given stationary phase particle size, better separation of analytes occurs with a greater plate height, which can be attained with a greater column length.

Unfortunately, known methods of packing stationary phase particles in separation columns become problematic with increased separation column length. For example, in one known method, high pressure is applied to a reservoir with a slurry. Initially, the liquid in the slurry flows through a frit at a comparatively high rate, and leaves the stationary phase particles in the column to for an HPLC column. However, as the HPLC column bed forms, the flow resistance increases as the column bed is formed. Even though a greater slurry pressure is applied, a point is reached where the flow rate becomes too low. As such, the longer the desired length of the separation column, the greater the time required to form the separation column.

Moreover, the slower packing process that results from increased flow resistance with increased column rate deleteriously impacts the quality of the column bed. Generally, the packing density of the stationary phase particles is directly proportional to the flow rate of the slurry. This results in a non-uniform particle density distribution along the length of the column and a packing density at one end of the microfluidic column that is greater than at another end of the column. As such, among other factors column length is limited in known microfluidic columns due to time intensive formation, and non-uniform packing density and distribution of the stationary phase particles.

What is needed, therefore, is a microfluidic device that overcomes at least the shortcomings described above.

### BRIEF DESCRIPTION OF THE DRAWINGS

The present teachings are best understood from the following detailed description when read with the accompanying drawing figures. The features are not necessarily drawn to scale. Wherever practical, like reference numerals refer to like features.

FIG. 1A shows a perspective view of a microfluidic device in accordance with a representative embodiment.

FIG. 1B shows a perspective view of a microfluidic device in accordance with a representative embodiment.

FIG. 1C shows a perspective view of a microfluidic device in accordance with a representative embodiment.

FIG. 1D shows a microfluidic connection in accordance with a representative embodiment.

FIG. 2 shows an exploded view of a microfluidic connection in accordance with a representative embodiment.

FIG. 3 shows graphs of separation data comparing a known separation column with microfluidic devices in accordance with a representative embodiment.

### DEFINED TERMINOLOGY

It is to be understood that the terminology used herein is for purposes of describing particular embodiments only, and is not intended to be limiting.

As used in the specification and appended claims, the terms ‘a’, ‘an’ and ‘the’ include both singular and plural referents, unless the context clearly dictates otherwise. Thus, for example, ‘a device’ includes one device and plural devices.

In this specification and in the claims that follow, reference will be made to a number of terms that shall be defined to have the following meanings:

The term ‘LC’ as used herein refers to a variety of liquid chromatography devices including, but not limited to HPLC devices;

The term ‘fluid-transporting feature’ as used herein refers to an arrangement of solid bodies or portions thereof that direct fluid flow. Fluid-transporting features include, but are not limited to, chambers, reservoirs, conduits, channels and ports.

The term ‘controllably introduce’ as used herein refers to the delivery of a predetermined volume of a fluid sample in a precise manner. A fluid sample may be ‘controllably introduced’ through controllable alignment of two components (i.e., fluid-transporting features) of a microfluidic device;

The term ‘flow path’ as used herein refers to the route along which a fluid travels or moves. Flow paths are formed from one or more fluid-transporting features of a microdevice;

The term ‘conduit’ as used herein refers to a three-dimensional enclosure formed by one or more walls and having an inlet opening and an outlet opening through which fluid may be transported;

The term ‘channel’ is used herein to refer to an open groove or a trench in a surface. A channel in combination with a solid piece over the channel forms a conduit; and

The term ‘fluid-tight’ is used herein to describe the spatial relationship between two solid surfaces in physical contact such that fluid is prevented from flowing into the interface between the surfaces.

The prefix “micro” as used in the term “microdevice” refers to a device having features of micron or submicron dimensions, and which can be used in any number of chemical processes or fluid transport techniques involving very small amounts of fluid. Such processes and techniques include, but are not limited to, electrophoresis (e.g., CE or MCE), chromatography (e.g., μLC), screening and diagnostics (using, e.g., hybridization or other binding means), and chemical and biochemical synthesis (e.g., DNA amplification as may be conducted using the polymerase chain reaction, or “PCR”). The features of the microdevices are adapted to the particular use. For example, microdevices may contain a microconduit on the order of 1 μm to 200 μm in diameter, typically 5 μm to 75 μm, when the cross sectional shape of the microconduit is circular, and approximately 1 mm to 100 cm in length. Other cross-sectional shapes, e.g., rectangular, square, triangular, pentagonal, hexagonal, etc., having dimensions similar to above may be employed as well. In any case, such a microconduit may have a volume of about 1 pl to about 100 μl, typically about 1 nl to about 20 μl, more typically about 10 nl to about 1 μl. Other uses of the prefix have an analogous meaning.

The term “substantially” as in “substantially identical in size” is used herein to refer to items that have the same or nearly the same dimensions such that corresponding dimensions of the items do not differ by more than approximately 15%. Preferably, the corresponding dimensions do not differ by more than 5% and optimally by not more than approximately 1%. For example, particles that are substantially identical in size have diameters that do not differ from each other by more than approximately 15%. Other uses of the term “substantially” have an analogous meaning.

### DETAILED DESCRIPTION

In the following detailed description, for purposes of explanation and not limitation, representative embodiments disclosing specific details are set forth in order to provide a thorough understanding of the present teachings. Descriptions of known systems, devices, materials, methods of operation and methods of manufacture may be omitted so as to avoid obscuring the description of the example embodiments. Nonetheless, systems, devices, materials and methods that are within the purview of one of ordinary skill in the art may be used in accordance with the representative embodiments.

Generally, it is understood that the drawings and the various elements depicted therein are not drawn to scale. Further, relative terms, such as “above,” “below,” “top,” “bottom,” “upper” and “lower” are used to describe the various elements' relationships to one another, as illustrated in the accompanying drawings. It is understood that these relative terms are intended to encompass different orientations of the device and/or elements in addition to the orientation depicted in the drawings. For example, if the device were inverted with respect to the view in the drawings, an element described as “above” another element, for example, would now be below that element.

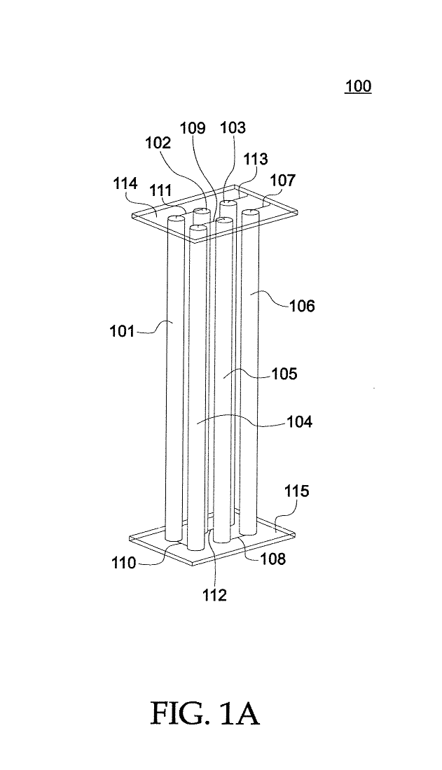

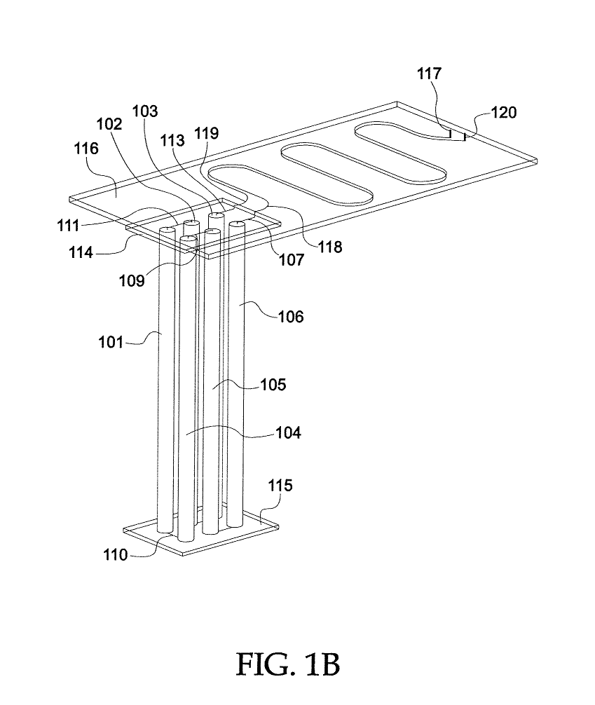

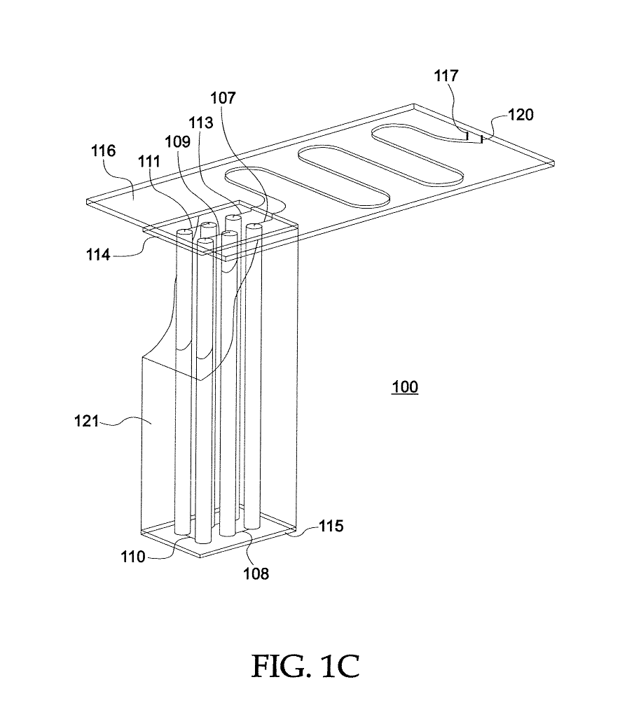

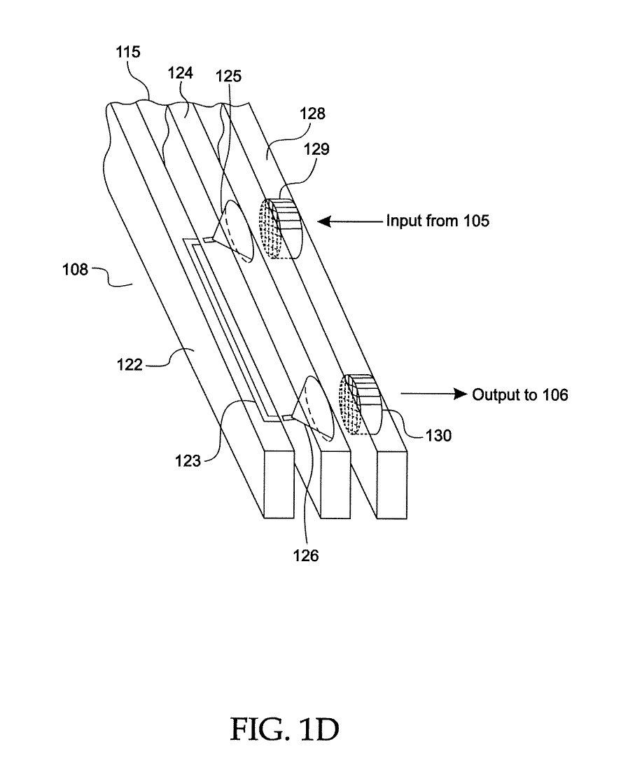

FIG. 1A shows a perspective view of a microfluidic device 100 in accordance with a representative embodiment. The microfluidic device 100 is contemplated for use with a variety of LC systems. For example, the LC system may be as described in U.S. Pat. No. 7,128,876 entitled ‘Microdevice and Method for Component Separation’ to Hongfeng Yin, et al.; commonly owned U.S. Pat. No. 6,845,968 entitled ‘Flow-Switching Microdevice’ to Kileen, et al.; and commonly owned U.S. patent application Ser. No. 12/022,684 (Attorney Docket Number 10060671-02), entitled ‘Microfluidic Device for Sample Analysis’ to Yin, et al., and filed on Jan. 30, 2008. The disclosures of these patents and patent application are specifically incorporated herein by reference. Repetition of certain features, dimensions, materials, methods of fabrication and methods of operation disclosed in these commonly-owned patents and patent application is generally avoided herein to avoid obscuring the description of representative embodiments.

The microfluidic device 100 may be used with one of a variety of detectors used in LC applications to provide a chromatogram for a sample. Illustratively, the LC detector (not shown) may be one of: a refractive index (RI) detector; an ultra-violet (UV) detector; a UV-Visible Light (UV-Vis) detector; a fluorescent detector (e.g., LIF detector); a radiochemical detector; an electrochemical detector; a near-infra red (Near-IR) detector; a mass spectroscopy (MS) detector; a nuclear magnetic resonance (NMR) detector; and a light scattering (LS) detector. It is emphasized that other types of detectors may be used. In the interest of ease of description, the detectors of the representative embodiments are absorption-type detectors that provide chromatograms of the radiation absorbed by the analytes of a sample.

The microfluidic device 100 comprises separation columns 101, 102, 103,104,105 and 106, which are selectively connected in series as described more fully below. In representative embodiments, the columns 101, 102, 103, 104, 105 and 106 are substantially linear or straight, and thus the microfluidic device 100 comprises multiple linear segments. Beneficially, the serial connection of the separation columns 101-106 results in an overall column length and separation medium packing density that are greater than known separation columns. In particular, and as described above, packing comparatively long single separation columns, and with comparatively small particles, such as for HPLC applications has proven exceedingly difficult, if attainable at all. By contrast, in accordance with the present teachings, a plurality of comparatively short separation columns are packed with separation particles at a sufficiently high packing density; and are connected in series to provide the microfluidic device 100 resulting in a comparatively long overall separation column.

In accordance with a representative embodiment, the particles have diameters ranging from approximately 1.0 μm to approximately 5.0 μm. Moreover, the lengths of the separation columns of the representative embodiments are in the range of approximately 30 mm to approximately 150 mm. The present embodiments contemplate serial connection of two columns to approximately 10 columns. The combined column length is contemplated to be approximately from approximately 60 mm to approximately 1500 mm.

The separation columns 101-106 may be fabricated from various materials depending on the application. For example, in HPLC applications in order to withstand the pressure required for packing via a slurry and for HPLC operations generally, the separation columns comprise a metal, or a polymer or a glass material capable of functioning at the comparatively high pressure required in HPLC applications. Illustratively, the metal may be steel, stainless steel or titanium. Polymers such as polyaryletheretherketone, commonly known as PEEK, are contemplated for use in columns 101-106. Columns 101-106 may comprise fused silica and steel or PEEK with silica lining such as Peeksil®. In addition to the desired properties for comparatively high pressure packing and operation, in certain embodiments, the materials used for the columns are selected for their ability to withstand heat, dissipate heat, or both during HPLC operations.

Any of a number of known liquid chromatographic packing materials may be included in the sample conduit. Such packing materials typically exhibit a surface area of approximately 100 m²/g to approximately 500 m²/g to achieve high separation efficiency and capacity. Accordingly, packing materials containing particles of different porosities may be advantageously used. In addition, packing materials may have surfaces that are modified for the intended separation of given classes of samples. For example, particles having different functionalities, e.g., different enzymes attached to beads, media having different chemical affinities and other functionalities may be used to separate and/or process samples that contain biomolecules such as nucleotidic and/or peptidic moieties. Furthermore, separation beads may be adapted to separate fluid sample components according to properties such molecular weight, polarity, hydrophobicity or charge.

In representative embodiments, the packing density of the separation material is substantially uniform along the length of each individual separation column 101, 102, 103, 104, 105 and 106. In some representative embodiments, one or more of the separation columns comprise separation materials that are substantially the same. Thus, in some embodiments, not only is the density of the separation media substantially the same but also the separation materials are substantially the same. In certain embodiments, therefore, the separation columns 101-106 are substantially the same. In other representative embodiments one or more of the separation columns 101-106 differ. For example, separation column 101 may comprise separation particles of a selected size, porosity and the like, and separation column 106 may comprise separation particles of a different size, porosity and the like.

The separation columns 101-106 are selectively connected via microfluidic connections (“connections”) 107,108, 109, 110, 111, 112 and 113, in an illustrative manner presently described. Connection 107 functions as an input to the microfluidic device 100 and receives a sample with analytes and a mobile phase. The connection 108 is connected between separation column 106 and separation column 105, and the sample flows from the connection 107 through separation column 106. Connection 108 receives the output of separation column 106, and provides an input to separation column 105. Thus, the sample from connection 107 has undergone a first separation via separation column 106.

The output from separation column 106 flows through the connection 108 and through separation column 105. Thus, the sample from connection 107 has undergone a second separation via separation column 105. Connection 109 is connected between separation column 105 and separation column 104.

The output of separation column 105 flows through the connection 109 and through separation column 104. Thus, the sample from connection 107 has undergone a third separation via separation column 104. Connection 110 is connected between separation column 104 and separation column 101. The output of separation column 104 flows through the connection 1110 and through separation column 101. Thus, the sample from connection 107 has undergone a fourth separation via separation column 101.

Connection 111 is connected between separation column 104 and separation column 101. The output from separation column 101 flows through the connection 111 and through separation column 102. Thus, the sample from connection 107 has undergone a fifth separation via separation column 102.

Connection 112 is connected between separation column 102 and separation column 103. The output from separation column 102 flows through the connection 112 and through separation column 103. Thus, the sample from connection 107 has undergone a sixth separation via separation column 103. Connection 107 provides the output from the microfluidic device 100 for further processing in an LC or HPLC system, not shown.

The connection of the columns 101-106 in series provides a separation medium having an equivalent column length that is greater in density and more uniform than can be attained using a single column due to limitations in the packing process discussed above. Stated somewhat differently, the plate number attained by the serial connection of columns 101-106 is greater than can be attained using a single column due to limitations in the packing process discussed above. As mentioned above, the lengths of the individual columns 101-106 is approximately 30 mm to approximately 150 mm L; and the particles have a diameter of approximately 1.0 μm to approximately 5.0 μm.

In certain representative embodiments, the individual lengths and diameters of the columns 101-106 can be substantially the same. This is not required, and for certain applications it is beneficial that one or more columns 101-106 have different dimensions (length, or diameter, or both) than other columns 101-106. Moreover, representative embodiments contemplate that packing density, or the particle size of the separation medium, or both, of each of the columns are substantially the same. However, this is not essential, and representative embodiments contemplate that the packing density, or the particle size of the separation medium, or both, of one or more of the columns 101-106 are different. For example, in a representative embodiment, column 106, which receives the input to the microfluidic device 100 from connection 107 may have a greater diameter and the particle size of the separation medium can be greater than column 103, which provides the output from the microfluidic device 100 via connection 113. Often, there is a limit on the pressure the LC pump can supply. This limits the total length of the column with given particle diameter/size. Comparatively small particles provide comparatively high separation performance but require comparatively higher pump pressure. Because the final column segment provides the greatest separation and thus the highest contribution to column performance, in one embodiment, the first column segment is packed with comparatively large particles and the last column segment is packed with comparatively small particles. This embodiment may provide comparatively high separation per unit of LC pressure. Moreover, the columns 101, 102, 104,105 and 106 may have different diameters, or may comprise particles of different sizes, or both. For example, by providing a first column with comparatively large diameter, a higher sample loading capacity can be attained. Still alternatively, the columns 101-106 may have substantially the same diameters, or may be packed with particles of substantially the same size, or both. Other combinations of column diameter and particle size are contemplated.

In accordance with a representative embodiment, the connections 107, 109, 111 and 113 are provide in a first substrate 114, and the connections 108, 110 and 112 are provided in a second substrate 115. The substrates 114, 115 provide structural support. Additionally, the substrates 114, 115 may comprise material useful in dissipating heat that can develop in certain applications, such as HPLC applications. The material selected for the substrates may be the same as used for the columns 101,102, 103, 104, 105 and 106; and the connections 107, 108,109,110,111,112 and 113 (e.g., to match thermal expansion characteristics) or different from the material of the columns 101-106.

FIG. 1B shows a perspective view of microfluidic device 100 in accordance with a representative embodiment. Many of the details provided in the description of the embodiments depicted in FIG. 1A are common to the description of the embodiments depicted in FIG. 1A and are not repeated in order to avoid obscuring the former. The microfluidic device 100 is connected to a substrate 116, which may be a component of an LC or HPLC microfluidic device such as described in the applications and patents referenced above. The substrate 116 comprises an inlet 117 to a first capillary 118 and an outlet 120 coupled to a second capillary 119. A sample is provided to the inlet 117 flows through the first capillary 118 to connection 107. The sample then travel through the serially connected separation columns 101-106, via connections 108,109, 110, 111 and 112 as described above. The sample then flows through connection 113 to the second capillary 119 and to the outlet 120. Having gone through separation, the sample is provided to a detector (not shown).

FIG. 1C shows a perspective view of microfluidic device 100 in accordance with a representative embodiment. Many of the details provided in the description of the embodiments depicted in FIG. 1D are common to the description of the embodiments depicted in FIGS. 1A and 1B and are not repeated in order to avoid obscuring the former. The microfluidic device 100 is provided in a sheath 121. The sheath 121 is shown in partial cut-away to partially reveal the housed separation columns 101, 104 and 105. Illustratively, the sheath 121 is disposed between substrates 114, 115. Among other functions, the sheath provides a heat sink to the separation columns 101-106 and the connections 107-113. As referenced above, certain LC processes and systems (e.g., HPLC) generate heat during operation. Dissipation of heat is useful to improve the accuracy and performance of the measurement. In a representative embodiment, the sheath 121 comprises material useful in dissipating heat. This material may be a metal such as titanium or steel. Moreover, the material selected for the sheath may be selected to substantially match the coefficient(s) of thermal expansion of the separation columns 101-106 and the connections 107-113. Among other benefits, this fosters maintaining of alignment of the components of the microfluidic device 100. The sheath 121 holds column hardware in position, and illustratively comprises steel, titanium or PEEK. As noted above, the columns may comprise steel, titanium, PEEK, or silica lined PEEK, or silica-lined steel.

FIG. 1D shows an exploded view of a microfluidic connection (“connection”) 108 provided in substrate 115 in accordance with a representative embodiment. The connections 107, 109-113 are provided in respective substrate 114, 115, and comprise the components of the connection 108 presently described. The substrate 115 and thus the connection 108 comprises material selected to substantially match the thermal expansion properties of the separation columns 105, 106 to foster maintaining proper alignment between the connection 108 and the columns 105,106. The material may be the same as that used to provide the columns, or another material having substantially the same thermal expansion coefficient. Moreover, the material selected for the connection 108 is selected to withstand the pressures and temperatures attained during HPLC testing.

Separation column 105 is connected to the ‘input’ of the connection 108, and separation column 106 is connected to the ‘output’ of the connection 108. The respective alignment between separation column 105 and connection 108, and the alignment of separation column 108 and connection is illustratively minimally approximately 50 μm and optimally be within 20 μm. The connection 108 comprises a first substrate 122, comprising a microfluidic channel 123. As should be appreciated by one of ordinary skill in the art, microfluidic channels that are not used for analyte separation result in ‘dead volume.’ The degree of dead volume is beneficially kept to a minimum in LC and HPLC systems to reduce band broadening. As such, the cross-sectional area of the microfluidic channel 123 is comparatively small, and particularly small compared to the diameter of the separation columns 105. The column diameter can range from approximately 0.1 mm interior diameter (i.d.) to approximately 4.6 mm i.d. and the microfluidic channel 123 has an interior diameter of approximately 15 μm for a 0.1 mm i.d. to approximately 0.15 mm for a 4.6 mm i.d.

The connection 108 comprises a second substrate 124 comprising a first flow distribution structure 125 and a second flow distribution structure 126. The flow distribution structures 125 and 126 foster a substantially consistent flow of fluid between the separation columns 105, 106 and the connection 108. In particular, due to the comparatively small cross-sectional area of the microfluidic channel 123 to the cross-sectional area of the separation column, in order to ensure even flow of the sample, the flow distribution structures 125, 126 are provided. The flow distribution structures 125, 126 are illustratively conically shaped as shown, although this is merely representative.

The connection 108 comprises a third substrate 128 comprising a first frit 129 and a second frit 130. The frits 129, 130 substantially maintain the particles provided in the separation columns 105, 106. Illustratively, the frits 129, 130 may be a mesh or polymer provided in openings in the substrate.

The sample is provided from the separation column 105 to the frit 129, flows through the frit 129 and is substantially evenly distributed by the first distribution structure 125 to the microfluidic channel 123. From the microfluidic channel 123, the sample is substantially even distributed by the second distribution structure 126 to the frit 129 and then is output to column 106 via the second frit 130.

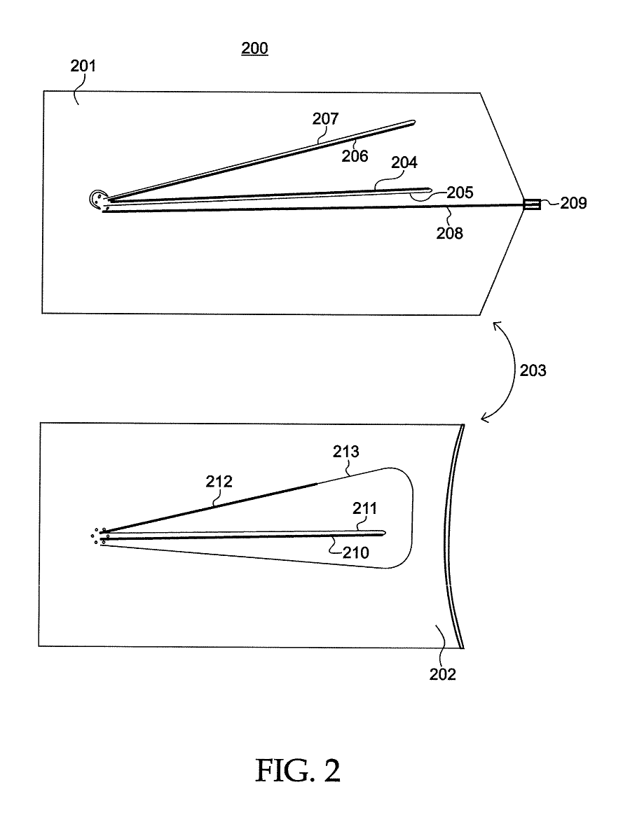

FIG. 2 shows an exploded view of a microfluidic device 200 in accordance with a representative embodiment. Like the embodiments described above, two or more columns are provided in fluid communication in series to provide a total column length with benefits described above in connection with the embodiments of FIGS. 1A-1D. Certain details of the microfluidic device 200 and the columns and connections thereof are common to the details of the columns described above and are not repeated in order to avoid obscuring the description of the presently described embodiments.

The device 200 comprises a first substrate 201 and a second substrate 202. In operation, the first substrate 201 is provided over the second substrate 202 as shown by the arrow 203. Notably, fluid connections between 207 and 212 are made for example using a rotor (not shown) and a stator (not shown) such as described in commonly owned U.S. Patent Application Publication 20030159993 to Hongfeng Yin, et al. The disclosure of this Publication is specifically incorporated herein by reference.

The first substrate 201 comprises a plurality of separation columns: a first column 204, a second column 206 and a third column 208. The first substrate 201 comprises respective fluid connections 205 and 207, the functions of which are described below. Column 208 is the last column in a series described presently, and is connected to an outlet 209.

The second substrate 202 comprises a fourth column 210, and a fifth column 212. Fluid connections 211 and 213 are provided as shown. When the first substrate 201 is provided over the second substrate 202 fluid connections are selectively made, and thereby five columns are provided in series.

A sample is provided at an inlet (not shown) to the first column 204 and is provided by connection 205 to column 210 on substrate 202. The sample is then provided to column 206 via connection 211, and to connection 212 via connection 207. The column 212 is connected to connection 213, and the sample travels through the fifth column 212. The sample is again traversed from substrate 202 back to substrate 201 and through column 208, which is connected to the outlet 209. At the outlet 209, the sample has traversed five columns. As such, the sequence of fluid flow of using the device 200 is through the first column 204, through connection 205, through column 210, through connection 211, through column 206, through connection 207, through column 212, through connection 213 through column 208 and through output 209.

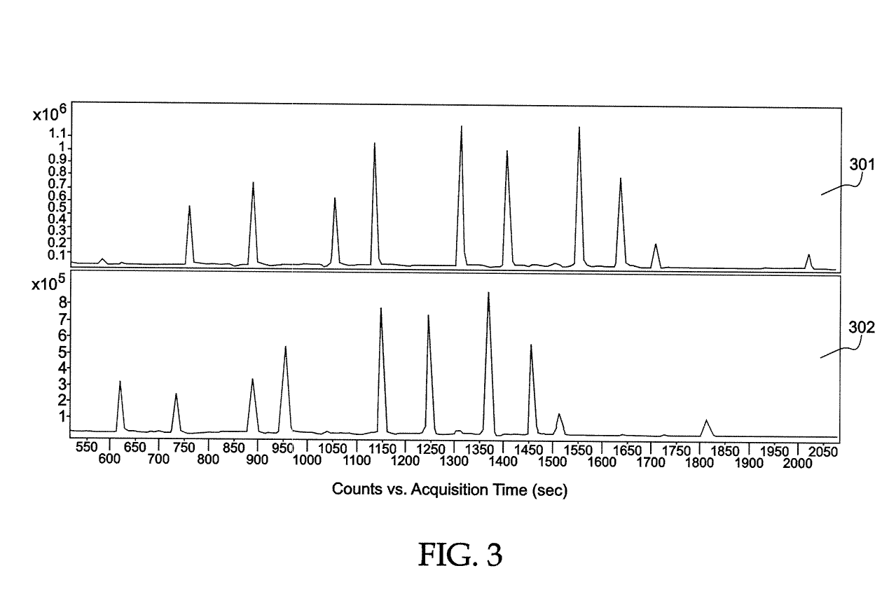

FIG. 3 shows graphs of separation data comparing a known separation column with microfluidic devices in accordance with a representative embodiment. Ten compounds from a Bovine serum albumin tryptic digest were selectively plotted in FIG. 3. The top trace 301 shows the separation with a five segment column microfluidic device where the combined length of the segments is 180 mm in accordance with a representative embodiment. Notably, the top trace 301 shows the results of a microfluidic separation column according to a representative embodiment comprising comprise five separation columns connected in series in a manner described above with reference to FIGS. 1A-2. The lower trace 302 is a known single separation column having a length of 150 mm. Comparison of traces 301, 302 shows that microfluidic column comprising a plurality of separation columns connected in series in accordance with a representative embodiment provides gives better separation than the known single 150 mm column. Notably, FIG. 3 shows that column comprising a plurality of separation columns connected in series in accordance with a representative embodiment provides significantly higher separation power (trace 301) than the known single long column (trace 302).

In view of this disclosure it is noted that the methods and microfluidic devices can be implemented in keeping with the present teachings. Further, the various components, materials, structures and parameters are included by way of illustration and example only and not in any limiting sense. In view of this disclosure, those skilled in the art can implement the present teachings in determining their own applications and needed components, materials, structures and equipment to implement these applications, while remaining within the scope of the appended claims.

1. A microfluidic device, comprising:
a microfluidic chip comprising:
a first substantially linear separation column having a first length, the first separation column comprising a first stationary phase particle density distribution along the first length;
a second substantially linear separation column having a second length connected in series with the first separation column, the second separation column comprising a second stationary phase particle density distribution along the second length.

2. A microfluidic device as claimed in claim 1, wherein the first stationary phase particle density distribution is substantially identical to the second stationary phase particle density distribution.

3. A microfluidic device as claimed in claim 1, wherein the first separation column is disposed over a first substrate.

4. A microfluidic device as claimed in claim 1, wherein the second separation column is disposed over a second substrate.

5. A microfluidic device as claimed in claim 1, wherein the first separation column and the second separation column are disposed over a common substrate.

6. A microfluidic device as claimed in claim 1, wherein the first separation column and the second separation column are disposed in a common sheath.

7. A microfluidic device as claimed in claim 1, further comprising a connecting fluid transporting feature configured to fluidly connect the first separation column and the second fluid separation column.

8. A microfluidic device as claimed in claim 7, wherein the connecting fluid transporting feature is disposed in a first substrate and the first separation column and the second separation column are disposed in a second substrate.

9. A microfluidic device as claimed in claim 8, further comprising a third substrate disposed between the first substrate and the second substrate, the third substrate comprising a flow distribution structure.

10. A microfluidic device as claimed in claim 9, further comprising a fourth substrate disposed between the first substrate and the second substrate, the fourth substrate comprising a column frit structure.

11. A microfluidic device as claimed in claim 7, wherein the connecting fluid transporting feature is disposed in a first substrate and the first separation column and the second separation column are disposed in a common sheath.

12. A microfluidic device as claimed in claim 1, wherein the first length is not less than one-third of the second length.

13. A microfluidic device as claimed in claim 1, wherein neither the first length nor the second length is less than approximately three centimeters.

14. A microfluidic chip, comprising:
more than one substantially linear separation column, wherein each of the separation columns are connected serially to another of the separation columns, and each of the separation columns comprises a substantially identical stationary phase particle density distribution.

15. A microfluidic chip as claimed in claim 14, wherein the first stationary phase particle density distribution is substantially identical to the second stationary phase particle density distribution.

16. A microfluidic chip as claimed in claim 14, further comprising a connecting fluid transporting feature configured to fluidly connect the first separation column and the second fluid separation column.

17. A microfluidic chip as claimed in claim 16, wherein the connecting fluid transporting feature is disposed in a first substrate and the separation columns in a second substrate.

18. A microfluidic chip as claimed in claim 17, further comprising a third substrate disposed between the first substrate and the second substrate, the third substrate comprising a flow distribution structure.

19. A microfluidic chip as claimed in claim 18, further comprising a fourth substrate disposed between the first substrate and the second substrate, the fourth substrate comprising a column frit structure.

20. A microfluidic chip as claimed in claim 19, wherein the connecting fluid transporting feature is disposed in a substrate and the separation columns are disposed in a common sheath.
